(19) United States
(12) Patent Application Publication
(10) Pub. No.: US 2016/0239187 A1
(43) Pub. Date: Aug. 18, 2016

(54) HANDS ON COMPUTERIZED EMULATION OF MAKE UP

(71) Applicant: INUITIVE LTD., Ra'anana (IL)

(72) Inventor: David BEN-BASSAT, Ganei Tikva (IL)

(21) Appl. No.: 15/027,789

(22) PCT Filed: Oct. 6, 2014
(86) PCT No.: PCT/IL2014/050872

§ 371 Date: Apr. 7, 2016

Related U.S. Application Data
(60) Provisional application No. 61/890,261, filed on Oct. 13, 2013.

(51) Int. Cl. G06F 3/0484; G06F 3/0481; G06F 3/0488; G06Q 30/06; G06T 19/20; G06T 15/50; H04N 7/18; G06T 17/00; G06F 3/0354

(52) U.S. Cl. CPC G06F 3/04845; G06T 17/00; G06F 3/04815; G06F 3/04883; G06F 3/03545; G06T 19/20; G06F 3/04842; G06T 15/50; H04N 7/183; G06Q 30/0643

(57) ABSTRACT

A system for computerized simulation of a make-up process is provided herein. The system includes: one or more capturing device configured to capture images of a face of a human user in controlled lighting conditions; a face reconstruction module configured to generate a 3D model of the face, based on the captured images; a display configured to present the reconstructed 3D model to the human user; a touch/3D user interface configured to receive a sequence of hand gestures and postures forming a virtual make-up session which imitates a real a make- up process; a virtual make-up simulator configured to apply virtual make-up features to the 3D model, to yield a 3D make-up model, based on said received hand gestures and postures, wherein said virtual make-up simulator repeatedly presents updated appearance of the 3D make-up model, over the display, responsive to changes made over said virtual make-up session.

### FIELD OF THE INVENTION

The present invention relates generally to the field of computerized selling of merchandise, and more particularly to computerized emulate for on-site visualization of merchandise.

### BACKGROUND OF THE INVENTION

Selling makeup at point of sales (aka “makeup kiosks”) presents various logistic challenges for makeup retailers. This is due to the unique nature of the makeup retail industry which usually involves on-site trial of the merchandise prior to buying. The on-site trial usually requires a booth and a marketing person assisting and advising the clients during trial of the makeup. Therefore, the on-site nature of makeup retail industry makes the selling of make-up more costly than other merchandise as makeup is sold less effectively on the Internet.

### BRIEF SUMMARY OF EMBODIMENTS OF THE INVENTION

According to some embodiments of the present invention, a system for providing a computerized emulation of a makeup trial process is provided herein. The system may include: one or more capturing device configured to capture images of a face of a human user in controlled lighting conditions; a face reconstruction module configured to generate a 3D model of the user face, based on the captured images; a display configured to present the reconstructed 3D model to the human user; a touch/3D user interface configured to receive a sequence of hand gestures and postures forming a virtual make-up session which imitates a real a make-up process; a virtual make-up simulator configured to apply virtual make-up features to the 3D model, to yield a 3D make-up model, based on said received hand gestures and postures, wherein said virtual make-up simulator repeatedly presents updated appearance of the 3D make-up model, over the display, responsive to changes made over said virtual make-up session. Advantageously, using touch and stylus, a user may mimic the process of applying makeup on the computerized image and see the immediate results on the screen.

These additional, and/or other aspects and/or advantages of the present invention are set forth in the detailed description which follows.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a high level block diagram illustrating another aspect of a system according to embodiments of the present invention;

FIG. 2 is a diagram illustrating one aspect of a system according to embodiments of the present invention; and

FIG. 3 is a high level flowchart illustrating an aspect of a method according to embodiments of the present invention.

The drawings together with the following detailed description make the embodiments of the invention apparent to those skilled in the art.

### DETAILED DESCRIPTION OF EMBODIMENTS OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

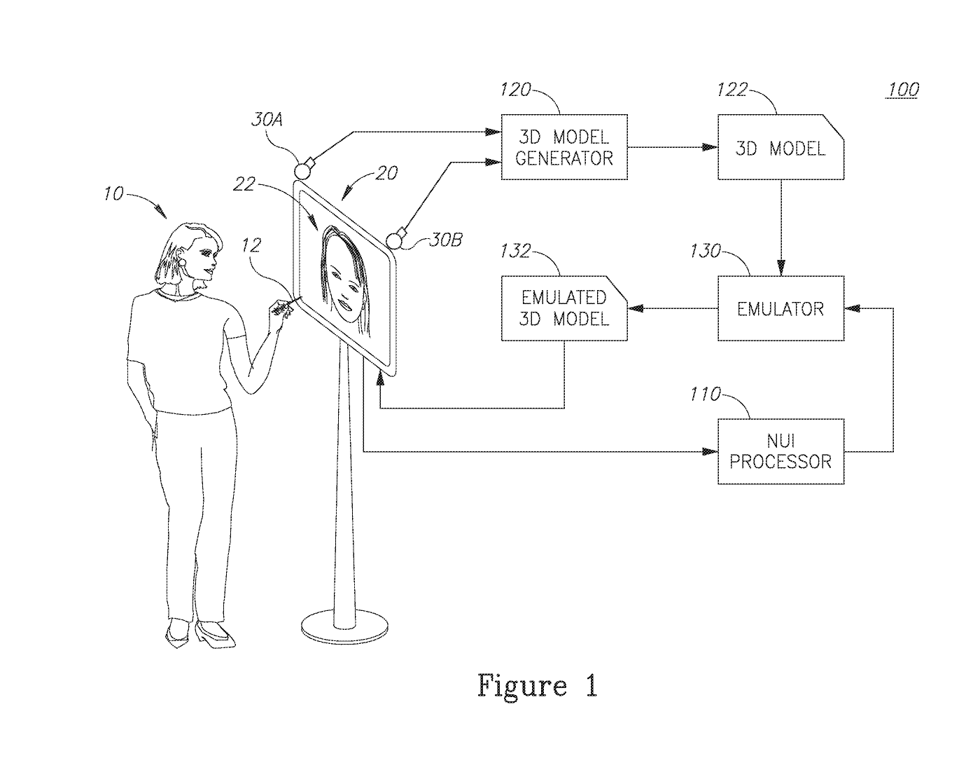

FIG. 1 is a diagram illustrating a system 100 according to embodiments of the present invention. A human user 10 stands in front of a virtual makeup emulation system 100 which may include an interactive display (e.g., touchscreen) 20 and a plurality of capturing devices 30A-30B such as web cams or the like that may capture the face of human user 10 from various angles.

System 100 may further include a 3D model generation generator 120 configured to receive he captured images of the head of user 10 and generate a 3D model 122. The 3D model is presented over display 20 which in turn can also be used may as a user interface, for example, as a touchscreen that is sensitive to both touch and stylus manipulation thereon. Touch signals and stylus strokes are being conveyed to a natural user interface (NUI) processor 110 which may be implemented as an application specific integrated circuit (ASIC) and configured to detect characteristic of desirable make up strokes which may include the location and path of the stroke of the fingers or the stylus over the 3D model, the amount of pressure applied and the like. NUI processor 110 provides the makeup strokes data to an emulator 130 which applies them to 3D model 122 and yields an emulated 3D model 132 which is then presented to user 10 over touchscreen 20 as an image 22 for further iteration in which user 10 can apply further touch and stylus strokes.

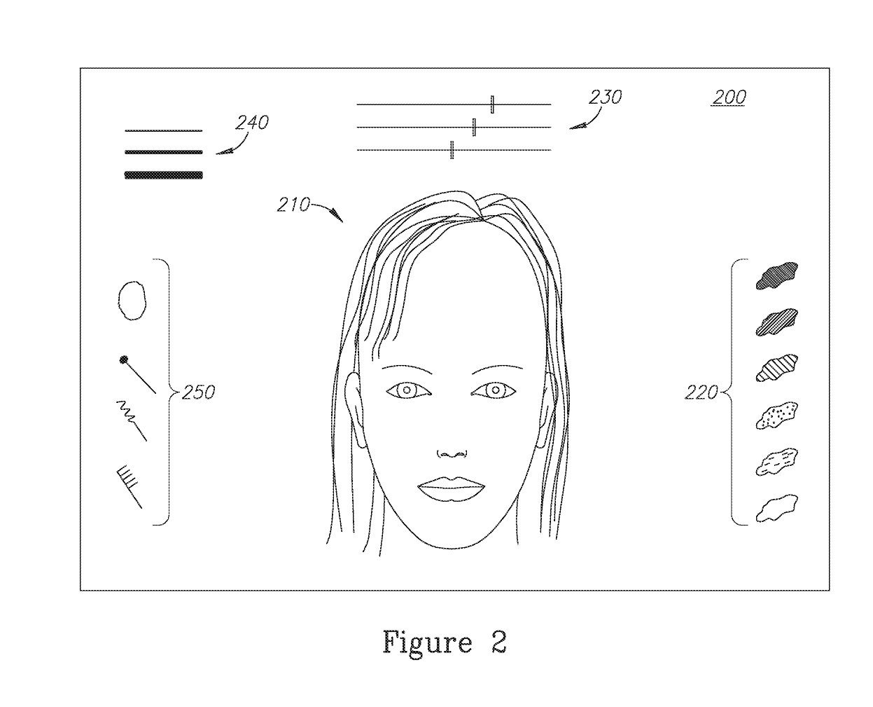

FIG. 2 is a diagram illustrating a potential graphical user interface (GUI) 200 that may be presented over display 20 detailed in FIG. 1. GUI 200 may include head image 210 that is a 3D image of human user 10 of FIG. 1, different types of makeup styluses 250 that may be picked by touch and stylus, different widths 240 for the makeup pencil, different lighting conditions as set forth and controlled via rulers 230 and various types and shades of makeup as shown in pallet 220. In operation, human user 10 may apply the makeup of his or her choice to image 220 and try various lighting conditions and different shades until he or she is satisfied with the results.

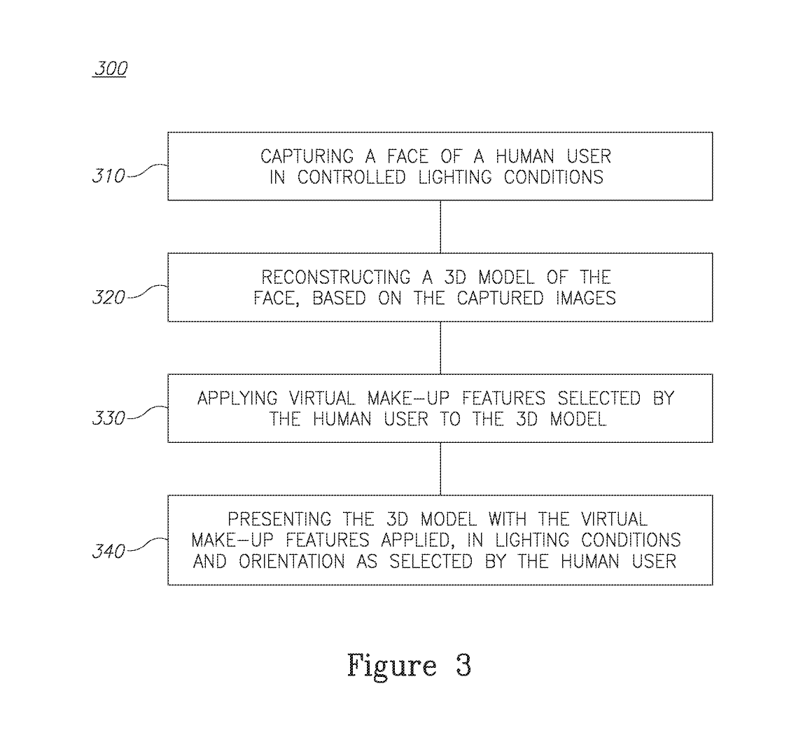

FIG. 3 is a high level flowchart illustrating an aspect of a method 300 according to embodiments of the present invention. It should be noted that method 300 is not necessarily implemented by the aforementioned architecture of system 300 and that the following steps may be residing in a computerized system other than the one illustrated above.

Method 300 may be implemented over a dedicated hardware may start with the step of capturing images of a face of a human user in controlled lighting conditions 310. Method 300 then goes on to generating a 3D model of the face, based on the captured images 320. then the method proceeds to presenting the reconstructed 3D model to the human user, receiving a sequence of hand gestures and postures as well as the use of touch and stylus forming a virtual make-up session which imitates a real a make-up process and applying virtual make-up features to the 3D model, to yield a 3D make-up model, based on said received hand gestures and postures 330; and ten goes on to repeatedly presenting updated appearance of the 3D make-up model, responsive to changes made over said virtual make-up session 340.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising:
at least one capturing device configured to capture images of a face of a human user;
a face reconstruction module configured to generate a 3D model of the face, based on the captured images;
a display configured to present the reconstructed 3D model to the human user;
a touch/3D user interface configured to receive a sequence of hand gestures and postures, touch and stylus forming a virtual make-up session which imitates a real make-up process;
a virtual make-up simulator configured to apply virtual make-up features to the 3D model, to yield a 3D make-up model, based on said received hand gestures and postures,
wherein said virtual make-up simulator repeatedly presents updated appearance of the 3D make-up model, over the display, responsive to changes made over said virtual make-up session.

2. The system according to claim 1, further comprising a display user interface configured to receive display requirements from the user relating to at least one of: lighting conditions and face orientation, and wherein the virtual make-up simulator is configured to reflect the display requirements in the updated 3D make-up model presented over the display.

3. The system according to claim 1, wherein the touch/3D user interface is implemented by the display.

4. The system according to claim 1, wherein the touch/3D user interface enables the human user to select a type of make-up using a graphical user interface presented over the display.

5. The system according to claim 1, further comprising a stylus detectable by the touch/3D user interface as a make-up applicator.

6. The system according to claim 1, wherein the touch/3D user interface is configured to detect specified hand postures or gestures as a corresponding make-up applicator selected by the user over a graphical user interface presented over the display.

7. The system according to claim 1, wherein the generated 3D model preserves original color and flesh tones of the face of the human user; comprises micro-texture data and resembles the face of the human user.

8. A method comprising:
capturing images of a face of a human user in controlled lighting conditions;
generating a 3D model of the face, based on the captured images;
presenting the reconstructed 3D model to the human user;
receiving a sequence of hand gestures and postures forming a virtual make-up session which imitates a real a make-up process;
applying virtual make-up features to the 3D model, to yield a 3D make-up model, based on said received hand gestures and postures; and
repeatedly presenting updated appearance of the 3D make-up model, responsive to changes made over said virtual make-up session.

9. The method according to claim 8, further comprising receiving display requirements from the user relating to at least one of: lighting conditions and face orientation, and reflecting the display requirements in the updated 3D make-up model presented to the human user.

10. The method according to claim 8, wherein the receiving and the presenting are carried out at the same location.

11. The method according to claim 8, further comprising enabling the human user to select a type of make-up using a graphical user interface presented over the display.

12. The method according to claim 8, further comprising providing a stylus detectable as a make-up applicator.

13. The method according to claim 8, further comprising detecting specified hand postures or gestures as a corresponding make-up applicator selected by the user over a graphical user interface presented to the human user.

14. The method according to claim 8, wherein the generated 3D model preserves original color and flesh tones of the face of the human user; comprises micro-texture data and resembles the face of the human user at 1 mm tolerance.

15. A tangible computer program product comprising:
a non-transitory computer readable storage medium having computer readable program embodied therewith, the computer readable program comprising:
computer readable program configured to capture images of a face of a human user in controlled lighting conditions;
computer readable program configured to generate a 3D model of the face, based on the captured images;
computer readable program configured to present the reconstructed 3D model to the human user;
computer readable program configured to receive a sequence of hand gestures and postures forming a virtual make-up session which imitates a real a make-up process;
computer readable program configured to apply virtual make-up features to the 3D model, to yield a 3D make-up model, based on said received hand gestures and postures; and
computer readable program configured to repeatedly present updated appearance of the 3D make-up model, responsive to changes made over said virtual make-up session.

16. The tangible computer program product according to claim 15, further comprising computer readable program configured to receive display requirements from the user relating to at least one of: lighting conditions and face orientation, and wherein a corresponding computer readable program is configured to reflect the display requirements in the updated 3D make-up model presented over the display.

17. The tangible computer program product according to claim 15, further comprising computer readable program configured to enable the human user to select a type of make-up using a graphical user interface presented over the display.

18. The tangible computer program product according to claim 15, further comprising computer readable program configured to detect a stylus as a make-up applicator.

19. The tangible computer program product according to claim 15, further comprising computer readable program configured to detect specified hand postures or gestures as a corresponding make-up applicator selected by the user over a graphical user interface.

20. The tangible computer program product according to claim 15, wherein the generated 3D model preserves original color and flesh tones of the face of the human user; comprises micro-texture data and resembles the face of the human user at 1 mm tolerance.
